(19) United States
(12) Patent Application Publication
(10) Pub. No.: US 2006/0081527 A1
(43) Pub. Date: Apr. 20, 2006

(54) Analytical filter

(75) Inventors: Katsuji Ichikawa, Shizuoka (JP); Nobuo Nakagawa, Kanagawa (JP); Mitsuhiko Oguchi, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/250,321

(22) Filed: Oct. 13, 2005

(30) Foreign Application Priority Data
Oct. 14, 2004 (JP) 2004-299692

(51) Int. Cl. B01D 29/13

(52) U.S. Cl. 210/483; 210/484; 210/506

(57) ABSTRACT

Embodiments of the invention eliminate, in an elemental analysis made of fine particles trapped using a conventional analytical filter, a hindrance to correct identification of elements of the fine particles as an original object of measurement that would otherwise cause the X-ray analyzer to measure elements of a filter base in addition to those of the fine particles. In one embodiment, an analytical filter includes a filter base and a metallic coating film. The filter base made of a resin has a plurality of filtering holes, each having a hole diameter ranging between about 100 nm and 1000 nm. The metallic coating film is formed on one face of the filter base through ion sputtering of gold (Au). The metallic coating film is so thick that an electron beam from an X-ray analyzer does not penetrate therethrough and the filtering holes are not plugged up. The metallic coating film is at least about 40 nm thick and is preferably about 40 nm to 100 nm thick.

### CROSS-REFERENCES TO RELATED APPLICATIONS

This application claims priority from Japanese Patent Application No. JP2004-299692, filed Oct. 14, 2004, the entire disclosure of which is incorporated here in reference.

### BACKGROUND OF THE INVENTION

The present invention relates generally to an analytical filter used for an X-ray analyzer, and more particularly, to an analytical filter for trapping fine particles contained in cleaning water used for cleaning components.

Machined devices and components are built into magnetic disk drives and other electronic units. The machined devices and components are contaminated with fine particles deposited thereon during machining. The machined devices and components are therefore cleaned before being mounted in the electronic unit. To determine possible effects of fine particles deposited on the devices and components included in the electronic unit, the X-ray analyzer comes into play for making an elemental analysis of the fine particles. To make the elemental analysis of the fine particles, a filter is used to trap fine particles contained in cleaning water used for cleaning the devices and components. The filter includes a filter base made of a resin, glass, a sintered metal, or any other single substance and having fine filtering holes.

Patent Document 1 (Japanese Patent Laid-open No. Hei 7-136430) discloses a filter medium, on which cake is hard to deposit and which is thus free from being plugged up, used in a filter press or other type of filter. The filter medium is made by vapor-depositing stainless steel, titanium, or the like on a base material made of a synthetic resin or the like and having fine permeable holes.

### BRIEF SUMMARY OF THE INVENTION

When an elemental analysis is made of fine particles by trapping the fine particles using the conventional analytical filter, an electron beam used for the elemental analysis tends more easily to penetrate through the fine particles as the particles become finer. Herein, characteristic X-rays of two types are applied to the X-ray analyzer. Specifically, one type of the characteristic X-ray is that generated when the electron beam hits against the fine particles. The other type of the characteristic X-ray is that generated when the electron beam penetrating through the fine particles reaches and hits against the filter base. This means that the X-ray analyzer takes measurement of not only the elements of the fine particles as the original object of measurement, but also the elements of the filter base. This has been a hindrance to identification of the elements of the fine particles as the original object of measurement. The filter medium as disclosed in Patent Document 1 is intended for use in a sludge dehydration apparatus or the like. The filter medium as disclosed in Patent Document 1 has a structure not good for trapping fine particles deposited on devices and components included in electronic units.

It is therefore a feature of the present invention to provide an analytical filter capable of suppressing generation of characteristic X-rays from the filter base and identifying elements of the fine particles trapped.

An analytical filter according to an aspect of the present invention includes a filter base and a metallic coating film. The filter base has a plurality of filtering holes, each having a hole diameter ranging between about 100 nm and 1000 nm. The metallic coating film is formed on at least one face of the filter base and has a thickness of about 40 nm to 100 nm.

In some embodiments, the metallic coating film includes at least one type of an element selected from the group consisting of gold, platinum, and palladium. The filter base is formed by a material selected from the group consisting of a resin, glass, and a sintered metal.

An analytical filter according to another aspect of the present invention includes a filter base, a reinforcement plate, and a metallic coating film. The filter base has a plurality of filtering holes, each having a hole diameter ranging between about 100 nm and 1000 nm. The reinforcement plate is affixed to at least one face of an outer edge of the filter base. The metallic coating film is formed on at least one face of the filter base and has a thickness of about 40 nm to 100 nm.

In some embodiment, the metallic coating film includes at least one type of an element selected from the group consisting of gold, platinum, and palladium. The filter base is formed by a material selected from the group consisting of a resin, glass, and a sintered metal.

An analytical filter according to still another aspect of the present invention includes a filter base, a net-like reinforcement plate, and a metallic coating film. The filter base has a plurality of filtering holes, each having a hole diameter ranging between about 100 nm and 1000 nm. The net-like reinforcement plate is affixed to at least one face of the filter base. The metallic coating film is formed on the other face of the filter base and has a thickness of about 40 nm to 100 nm.

In some embodiments, the metallic coating film includes at least one type of an element selected from the group consisting of gold, platinum, and palladium. The filter base is formed by a material selected from the group consisting of a resin, glass, and a sintered metal.

An analytical filter according to a further aspect of the present invention includes a filter base, a screen-like reinforcement plate, and a metallic coating film. The filter base has a plurality of filtering holes, each having a hole diameter ranging between about 100 nm and 1000 nm. The screen-like reinforcement plate is affixed to at least one face of the filter base. The metallic coating film is formed on the other face of the filter base and has a thickness of about 40 nm to 100 nm.

In some embodiments, the metallic coating film includes at least one type of an element selected from the group consisting of gold, platinum, and palladium. The filter base is formed by a material selected from the group consisting of a resin, glass, and a sintered metal.

An analytical filter according to a still further aspect of the present invention includes a metallic film. The metallic film has a plurality of filtering holes, each having a hole diameter ranging between about 0.1 μm and 1 μm, and has a thickness of several μm to several hundred μm.

According to the embodiments of the present invention, it is possible to provide an analytical filter capable of suppressing generation of characteristic X-rays from the filter base and identifying elements of the fine particles trapped.

### BRIEF DESCRIPTION OF THE DRAWINGS

FIG. 1 is a partly cross-sectional view showing an analytical filter according to an embodiment of the present invention.

FIG. 2 is a partly cross-sectional view showing a conventional analytical filter.

FIG. 3 shows diagrams indicating results of an elemental analysis made of particles trapped by a conventional resin filter and a metallic coating filter according to an embodiment of the present invention.

FIGS. 4A, 4B, and 4C are views showing means for preventing a metallic coating film from being deformed.

FIG. 5 is a partly cross-sectional view showing an analytical filter according to another embodiment of the present invention.

### DETAILED DESCRIPTION OF THE INVENTION

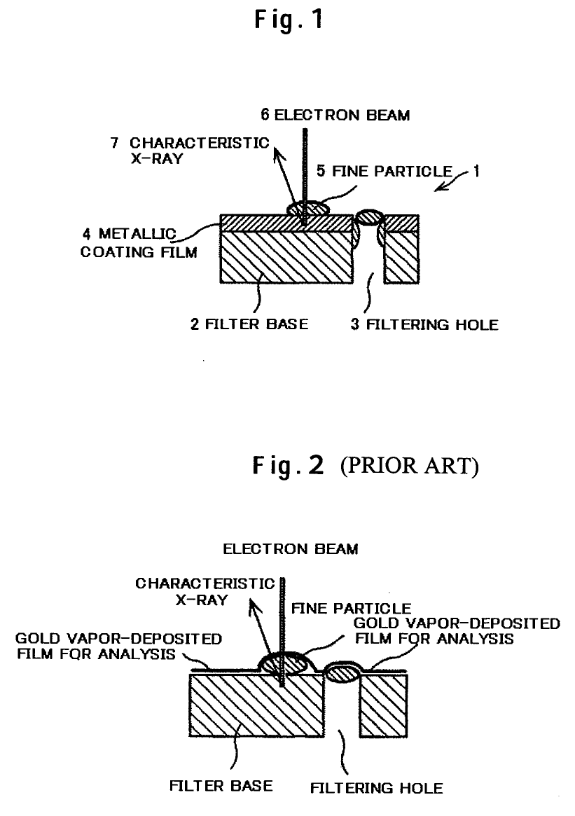

FIG. 1 is a partly cross-sectional view showing an analytical filter according to an embodiment of the present invention. An analytical filter 1 includes a filter base 2 and a metallic coating film 4. The filter base 2 is made of a resin having a plurality of filtering holes 3 with a hole diameter ranging from about 100 nm to 1000 nm. The metallic coating film 4 is formed through ion sputtering of gold (Au) on one surface of the filter base 2. The metallic coating film 4 is so thick that an electron beam from an X-ray analyzer does not penetrate therethrough and the filtering holes 3 are not plugged up. The metallic coating film 4 is at least about 40 nm thick, and is preferably about 40 nm to 100 nm thick.

A method for making an elemental analysis of a fine particle 5 trapped using the analytical filter 1 will be described. Machined devices and components to be built into a magnetic disk drive or other electronic unit are cleaned with water to wash away fine particles deposited thereon. The fine particle 5 is trapped from the cleaning water using the analytical filter 1. The analytical filter 1 that has trapped the fine particle 5 is mounted in an X-ray analyzer. The analytical filter 1 is then irradiated with an electron beam 6. The electron beam 6 penetrates through the fine particle 5, but reaches only up to the metallic coating film 4. A characteristic X-ray 7 is detected mainly from the fine particle 5 and the metallic coating film 4. Detection of the characteristic X-ray 7 from the filter base 2 is thus suppressed. Elements of the fine particle 5 can therefore be identified by subtracting elements obtained through the analysis made based on the characteristic X-ray from the metallic coating film 4 from elements obtained through the analysis made based on the characteristic X-ray from the fine particle 5 and the metallic coating film 4.

A comparison is herein made with a conventional resin filter not using any metallic coating film. Referring to FIG. 2, the conventional analytical filter works as follows. Specifically, fine particles are trapped and then a conductive film required for the X-ray analysis is formed through vapor deposition of gold or the like so that the conductive film covers also fine particles. The filter is then irradiated with the electron beam. The electron beam penetrates through the conductive film and the fine particles to reach up to the filter base. The X-ray analyzer therefore makes the elemental analysis by detecting characteristic X-rays from the conductive film, the fine particles, and the filter base. The resin forming the filter base includes carbon (C) and oxygen (O). Aluminum (Al) may be detected, in addition to carbon (C) and oxygen (O), in the characteristic X-rays from the electron beam that has penetrated through the fine particles and reached the filter base. If the aluminum is detected, it is difficult to determine whether the aluminum is a single metal (Al) or an oxide (Al—O) combined with oxygen (O).

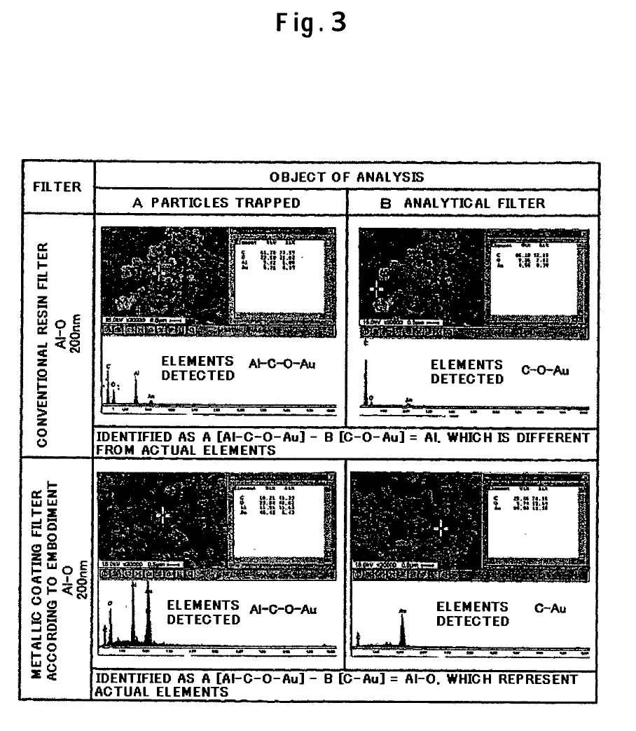

The method for the elemental analysis will be described in greater detail with reference to FIG. 3. FIG. 3 presents diagrams showing surfaces of the analytical filters observed through a scanning electron microscope and results of the analysis made with the X-ray analyzers. An aluminum oxide (Al—O) having a particle diameter of 200 nm was used as testing fine particles. The aluminum oxide (Al—O) was trapped by using the conventional resin filter and analyzed with the X-ray analyzer. As a result, the elements detected were Al—C—O—Au. Elements detected from portions of the resin filter where no fine particles exist were C—O—Au. Subtracting the elements detected in portions where no fine particles exist from those detected in portions where fine particles exist yields Al. The Al—O actually used was not identified. This is because the oxygen (O) contained in the resin filter base overlaps the oxygen (O) of the aluminum oxide.

The analytical filter coated with gold (Au) according to a specific embodiment of the present invention was used to trap the aluminum oxide (Al—O). The elements detected from portions where the aluminum oxide (Al—O) existed were Al—C—O—Au. The elements detected from portions where the aluminum oxide (Al—O) did not exist were mainly C—Au, with an extremely suppressed amount of O. Subtracting the elements detected in portions where no aluminum oxide (Al—O) exists from those detected in portions where the aluminum oxide (Al—O) exists yields Al—O. The actual elements of the fine particles were thus correctly identified. In addition, in the analytical filter according to this embodiment of the present invention, the metallic coating film is formed on the filter base, which eliminates the necessity for forming a conductive film required for elemental analysis.

According to this embodiment of the present invention, gold (Au) is used as the metallic coating film covering the filter base. Instead of using gold (Au), platinum (Pt) or palladium (Pd) may be used. An alloy of these metals may even be used. Further, according to the present embodiment of the present invention, the metallic coating film is formed through ion sputtering. Instead of using the ion sputtering, vapor deposition may be used to form the metallic coating film. According to the present embodiment of the invention, a resin is used for the filter base. Instead of using the resin, glass or a sintered metal may be used for the filter base.

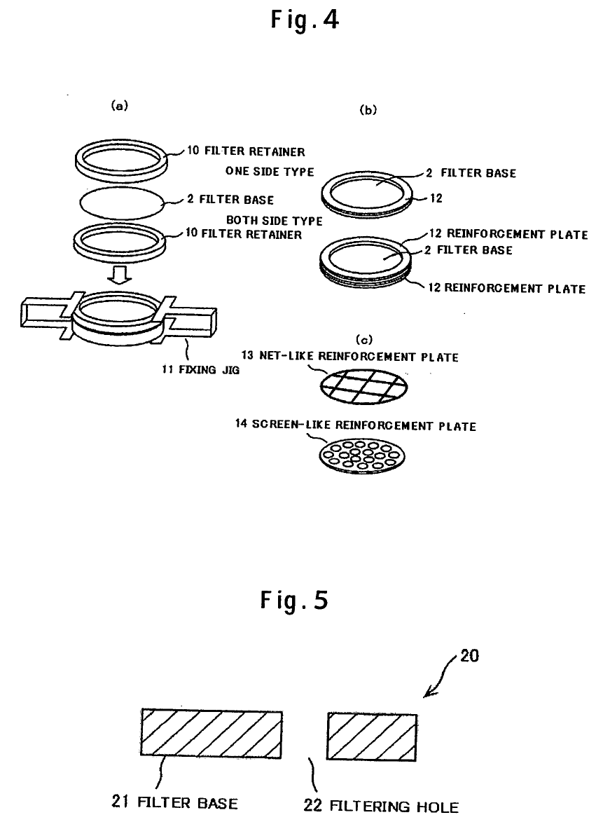

In the analytical filter according to the aforementioned embodiment of the present invention, the filter base may be deformed by stress applied by the coating metal or heat generated during treatment. The following methods may be employed to prevent the filter base from being deformed. Referring to FIG. 4A, the filter base 2 is sandwiched between filter retainers 10 on a top side and a bottom side thereof around a periphery thereof. A fixing jig 11 for the exclusive use for the fixing purpose is used to secure the filter base 2 in a taut state thereof. A metallic coating film is then formed. Referring to FIG. 4B, a metallic coating film is formed by affixing a reinforcement plate 12 to one side or both sides of the filter base 12 on an outer edge thereof with an adhesive or the like. Referring to FIG. 4C, a metallic coating film is formed by affixing a surface reinforcement plate to one side of the filter base with an adhesive or the like. A net-like reinforcement plate 13 or a screen-like reinforcement plate 14 should preferably be used for the surface reinforcement plate.

An analytical filter 20 according to another embodiment of the present invention will be described with reference to a partly cross-sectional view shown in FIG. 5. A filter base 21 is formed with a metallic film having a thickness of several μm to several hundred μm. A filtering hole 22 is formed by making a through hole having a hole diameter of 0.1 μm to 1 μm in the filter base 21 with an electron beam or a laser. Gold (Au), platinum (Pt), palladium (Pd), or an alloy of these metals should preferably be used for the metallic film 21. The same effect as that produced from the first embodiment of the present invention can be obtained from this second embodiment of the present invention.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims alone with their full scope of equivalents.

What is claimed is:

1. An analytical filter, comprising:
a filter base having a plurality of filtering holes, each having a hole diameter ranging between about 100 nm and 1000 nm; and
a metallic coating film formed on at least one face of the filter base and having a thickness of at least about 40 nm.

2. The analytical filter according to claim 1 wherein the metallic coating film has a thickness of about 40 nm to 100 nm.

3. The analytical filter according to claim 1,
wherein the metallic coating film includes at least one type of an element selected from the group consisting of gold, platinum, and palladium.

4. The analytical filter according to claim 1,
wherein the filter base is formed by a material selected from the group consisting of a resin, glass, and a sintered metal.

5. An analytical filter, comprising:
a filter base having a plurality of filtering holes, each having a hole diameter ranging between about 100 nm and 1000 nm;
a reinforcement plate affixed to at least one face of an outer edge of the filter base; and
a metallic coating film formed on at least one face of the filter base and having a thickness of at least about 40 nm.

6. The analytical filter according to claim 5 wherein the metallic coating film has a thickness of about 40 nm to 100 nm.

7. The analytical filter according to claim 5,
wherein the metallic coating film includes at least one type of an element selected from the group consisting of gold, platinum, and palladium.

8. The analytical filter according to claim 5,
wherein the filter base is formed by a material selected from the group consisting of a resin, glass, and a sintered metal.

9. An analytical filter, comprising:
a filter base having a plurality of filtering holes, each having a hole diameter ranging between about 100 nm and 1000 nm;
a net-like reinforcement plate affixed to at least one face of the filter base; and
a metallic coating film formed on at least one face of the filter base and having a thickness of at least about 40 nm.

10. The analytical filter according to claim 9 wherein the metallic coating film has a thickness of about 40 nm to 100 nm.

11. The analytical filter according to claim 9,
wherein the metallic coating film includes at least one type of an element selected from the group consisting of gold, platinum, and palladium.

12. The analytical filter according to claim 9,
wherein the filter base is formed by a material selected from the group consisting of a resin, glass, and a sintered metal.

13. An analytical filter, comprising:
a filter base having a plurality of filtering holes, each having a hole diameter ranging between about 100 nm and 1000 nm;
a screen-like reinforcement plate affixed to at least one face of the filter base; and
a metallic coating film formed on at least one face of the filter base and having a thickness of at least about 40 nm.

14. The analytical filter according to claim 13 wherein the metallic coating film has a thickness of about 40 nm to 100 nm.

15. The analytical filter according to claim 13,
wherein the metallic coating film includes at least one type of an element selected from the group consisting of gold, platinum, and palladium.

16. The analytical filter according to claim 13,
wherein the filter base is formed by a material selected from the group consisting of a resin, glass, and a sintered metal.

17. An analytical filter, including:
a metallic film having a plurality of filtering holes, each having a hole diameter ranging between about 0.1 μm and 1 μm, and having a thickness of several μm to several hundred μm.

18. The analytical filter according to claim 17,
wherein the metallic film includes at least one type of an element selected from the group consisting of gold, platinum, and palladium.
